(19) United States
(12) Patent Application Publication
(10) Pub. No.: US 2007/0133950 A1
(43) Pub. Date: Jun. 14, 2007

(54) Reproduction apparatus, reproduction method, recording method, image display apparatus and recording medium

(76) Inventors: Susumu Yoshida, Kawasaki (JP); Takuya Imaide, Fujisawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/634,964

(22) Filed: Dec. 7, 2006

(30) Foreign Application Priority Data
Dec. 8, 2005 (JP) 2005-354313
Dec. 8, 2005 (JP) 2005-354314

(51) Int. Cl. H04N 5/91

(52) U.S. Cl. 386/108

(57) ABSTRACT

A reproduction apparatus on which secondary video, which is displayed as a picture in picture video, is encoded in such a way that the secondary video information has an HD-size resolution as a video but its effective area is equal to or lower than a predetermined ratio of the whole size. This reproduction apparatus reduces the processing load at reproduction time, uses effective area information to determine the opacity level in combining the videos and, therefore, prevents primary video from being hidden by the secondary video in an area where the primary video should not be hidden.

### INCORPORATION BY REFERENCE

The present application claims priorities from Japanese applications JP2005-354313 filed on Dec. 8, 2005, JP2005-354314 filed on Dec. 8, 2005, the contents of which are hereby incorporated by reference into this application.

### BACKGROUND OF THE INVENTION

The present invention relates to a reproduction method, a reproduction apparatus, and an image display apparatus for reproducing data from a recording medium, and more particularly to the implementation of the picture in picture function. The present invention also relates to a recording medium corresponding to the picture in picture function and to a recording method for recording data on the recording medium.

The background technology related to the picture in picture function is disclosed in JP-A-2005-123775.

More specifically, to implement the picture in picture function and the wallpaper display function in a BD-ROM, a secondary video plane 50 that displays a moving image is added to planes 10, 11, and 12 that display a moving image, a subtitle, and graphics, respectively. The outputs of the secondary video plane 50 and the video plane 10 are selected on a pixel unit by a switch 51. Contracted moving image data is stored in the secondary video plane 50, and the switch 51 is controlled to be switched on a pixel unit corresponding to the display position of the contracted moving image data, and thereby the contracted moving image data of the secondary video plane 50 is displayed in a small screen when the moving image data of the video plane 10 is displayed. With the wallpaper image data stored instead of the moving image data in the video plane 10, the screen is displayed as if the wallpaper was displayed in the background of the contracted moving image data (see the Abstract of JP-A-2005-123775).

JP-A-2005-123775 also discloses a technology that uses multiple video planes or multiple frame buffers to select a desired output on a pixel basis to implement the picture in picture function more specifically. With particular emphasis on video data, the invention discloses the configuration of a player/decoder that implements the picture in picture function where one MPEG video decoder is used to decode two moving image streams.

### SUMMARY OF THE INVENTION

To do so, an actual player is required to have the hardware configuration in which one video decoder decodes two moving image streams on a time division basis. The processing amount of the picture in picture function, sometimes required to perform synchronized reproduction, varies greatly according to the encoding method and encoding rate of a moving image stream to be decoded and the size of an image to be processed. That is, whether or not a player can perform the picture in picture function depends on the processing ability of the decoder. In particular, when data is reproduced on a PC, processing such as the decoding of a moving image or an audio is sometimes performed, in whole or in part, by software. In this case, the processing amount depends on the CPU capabilities such as the operation frequency.

According to the technology disclosed in JA-A-2005-123755, the size of a video plane used for a video being reproduced in a large screen (called primary video) and the size of a video plane used for a video displayed as a picture in picture video in a small screen (called secondary video) are the same with no particular limit on the image sizes. That is, the picture in picture function is implemented with no special consideration for the processing amount.

In view of the foregoing, it is an object of the present invention to provide a reproduction apparatus, a reproduction method, a recording method, an image display apparatus, and a recording medium that implement the picture in picture function considering a reduction in the processing load.

The above object is achieved by the following reproduction apparatus, reproduction method, recording method, image display apparatus, and recording medium.

1.) A reproduction apparatus comprising:

first decoding unit that decodes encoded data of primary video information; and

second decoding unit that decodes encoded data of secondary video information, wherein

the reproduction apparatus can output the secondary video information on a display apparatus in synchronization with the primary video information, and

a size of an effective area of the secondary video information on a screen is smaller than a size of the primary video information on the screen,

the reproduction apparatus further comprising display video formation unit that forms a display video using the primary video information and the secondary video information.

2.) A reproduction method comprising the steps of:

decoding encoded data of primary video information and encoded data of secondary video information; and

outputting the secondary video information on a display apparatus in synchronization with the primary video information, wherein

a size of an effective area of the secondary video information on a screen is smaller than a size of the primary video information on the screen, and

a display video is formed using the primary video information and the secondary video information.

3.) A recording method for recording primary video information and secondary video information, comprising the steps of:

specifying an effective area of the secondary video information; and

recording the specified effective area along with the secondary video information, the specified effective area recorded as auxiliary information, wherein

a size of the effective area of the secondary video information on a screen is smaller than a size of the primary video information on the screen, and

the primary video information and the secondary video information are recorded so that the primary video information and secondary video information are synchronized on a display screen.

4.) A video display apparatus comprising:

a reception unit that receives primary video information and secondary video information;

first decoding unit that decodes encoded data of the primary video information;

second decoding unit that decodes encoded data of the secondary video information; and

a display unit that displays the secondary video information in synchronization with the primary video information, wherein

a size of an effective area of the secondary video information on a screen is smaller than a size of the primary video information on the screen,

the image display apparatus further comprising display video formation unit that forms a display video using the primary video information and the secondary video information.

5.) A recording medium on which primary video information and secondary video information are recorded, wherein

auxiliary information on an effective area of the secondary video information is recorded,

a size of the effective area of the secondary video information on a screen is smaller than a size of the primary video information on the screen, and

the primary video information and the secondary video information are synchronized and displayed on the screen.

6.) A reproduction apparatus comprising:

first decoding unit that decodes encoded data of primary video information; and

second decoding unit that decodes encoded data of secondary video information, wherein

the reproduction apparatus can output the secondary video information on a display apparatus in synchronization with the primary video information,

a size of the secondary video information on a screen is smaller than a size of the primary video information on the screen, and

the secondary video information is displayed in a divided form,

the reproduction apparatus further comprising display video formation unit that forms a display video using the primary video information and the secondary video information; and

control unit that controls the display video formation unit.

7.) A reproduction method comprising the steps of:

decoding encoded data of primary video information and encoded data of secondary video information; and

outputting the secondary video information on a display apparatus in synchronization with the primary video information, wherein

a size of the secondary video information on a screen is smaller than a size of the primary video information on the screen,

the secondary video information is displayed in a divided form, and

a display video is formed using the primary video information and the secondary video information.

8.) A recording method for recording primary video information and secondary video information, comprising the steps of:

creating auxiliary information on position information on multiple divided areas of the secondary video information; and

recording the created auxiliary information along with the secondary video information, wherein

a size of the secondary video information on a screen is smaller than a size of the primary video information on the screen and

the primary video information and the secondary video information are recorded so that the primary video information and secondary video information are synchronized on a display screen.

9.) A video display apparatus comprising:

a reception unit that receives primary video information and secondary video information;

first decoding unit that decodes encoded data of the primary video information;

second decoding unit that decodes encoded data of the secondary video information; and

a display unit that displays the secondary video information in synchronization with the primary video information, wherein

a size of the secondary video information on a screen is smaller than a size of the primary video information on the screen, and

the secondary video information is displayed in a divided form,

the image display apparatus further comprising display video formation unit that forms a display video using the primary video information and the secondary video information.

10.) A recording medium on which primary video information and secondary video information are recorded, wherein

auxiliary information that is position information on the secondary video information is recorded,

a size of the secondary video information on a screen is smaller than a size of the primary video information on the screen,

the secondary video information is displayed in a divided form, and

the primary video information and the secondary video information are synchronized and displayed on the screen.

The reproduction apparatus, reproduction method, recording method, image display apparatus, and recording medium according to the present invention reduce the processing amount in the reproduction apparatus.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing a reproduction apparatus in an embodiment.

FIG. 2 is a diagram showing an example of the configuration of a display video formation unit in a first embodiment of the present invention.

FIG. 3 is a diagram showing the basic image of the picture in picture function.

FIG. 4 is a diagram showing the picture in picture function when secondary video information is the HD size.

FIGS. 5A and 5B are diagrams showing an example of an effective area limitation in secondary video information.

FIG. 6 is a diagram showing the encoding of video data.

FIGS. 7A and 7B are diagrams showing an example of the division of secondary video information.

FIG. 8 is a diagram showing an example of the configuration of a display video formation unit in a second embodiment of the present invention.

FIG. 9 is a diagram showing the picture in picture function when secondary video information is the SD size.

FIG. 10 is a block diagram showing a recording apparatus in a third embodiment.

### DESCRIPTION OF THE EMBODIMENTS

Embodiments of the present invention will be described below with reference to the drawings.

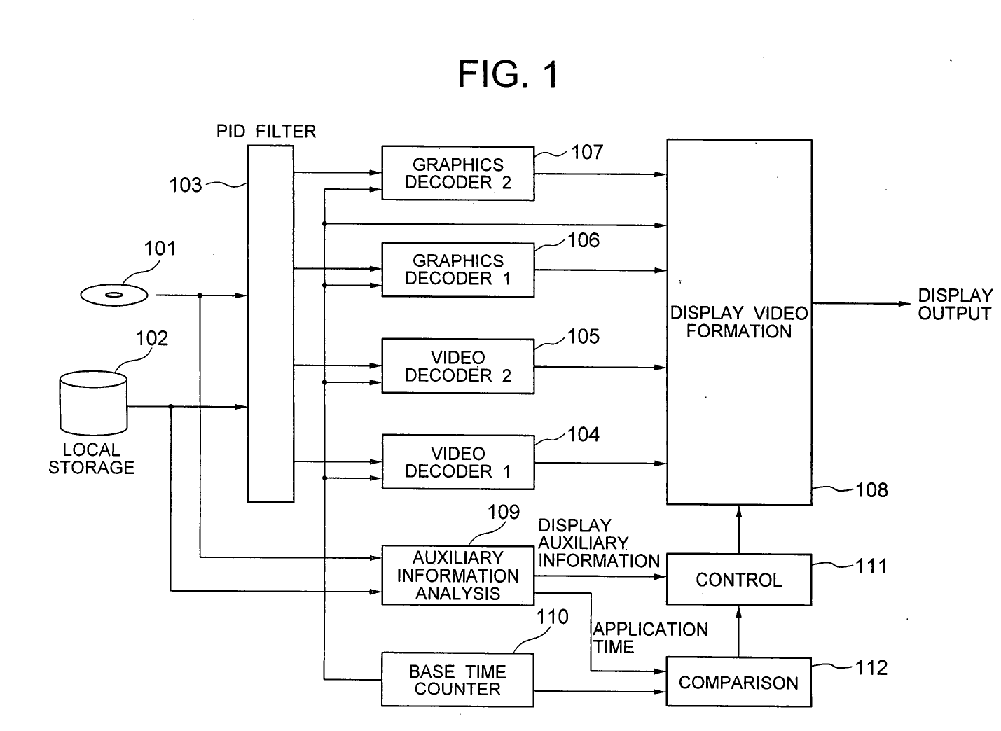

FIG. 1 is a block diagram showing a reproduction apparatus in a first embodiment of the present invention. The numeral 101 indicates an optical disc, the numeral 102 indicates local storage, the numeral 103 indicates a PID filter, the numeral 104 indicates a video decoder 1, the numeral 105 indicates a video decoder 2, the numeral 106 indicates a graphics decoder 1, the numeral 107 indicates a graphics decoder 2, the numeral 108 indicates a display video formation unit, the numeral 109 indicates an auxiliary information analysis unit, the numeral 110 indicates a base time counter unit, the numeral 111 indicates a control unit, and the numeral 112 indicates a comparison unit.

The optical disc 101 and the local storage 102 store graphics information, such as primary video information, secondary video information, subtitle information, and menu information, and auxiliary information associated with them. Although data may be stored in any of the two, optical disc 101 or local storage 102, in the present invention, the primary video information, the subtitle information, the menu information, and the associated auxiliary information are stored on the optical disc 101, and the secondary video information and the associated auxiliary information are stored in the local storage 102, in this embodiment for simplicity of the description. In this embodiment, both the primary video information and the secondary video information are assumed to be HD-size image data. Although audio information is usually multiplexed in the primary video information and the secondary video information, the following primarily describes video information because the present invention focuses on the display method of videos.

Encoded data (stream) is recorded on the optical disc 101 and the local storage 102 in the packetized and multiplexed format conforming to the MPEG2 system standard.

First, a stream read from the optical disc 101 is distributed to its destination by the PID filter 103 according to the PID (packet ID). The moving image stream of the primary video is input to a video decoder 1 (104). The video decoder 1 (104) decodes the received moving image stream and outputs the resulting primary video to the display video formation unit 108. When the stream is subtitle information, the stream is input to the graphics decoder 1 (106). The graphics decoder 1 (106) performs necessary rendering according to the received subtitle information stream and outputs the resulting graphics information to the display video formation unit 108. Similarly, when the stream input to the PID filter is menu information, the stream is input to the graphics decoder 2 (107). The graphics decoder 2 (107) prepares the required GUI parts according to the stream such as the received menu information, and outputs the resulting graphics information to the display video formation unit (108).

The secondary video encoded data, read from the local storage 102, is distributed also by the PID filter 103 and is input to the video decoder 2 (105). The video decoder 2 (105) decodes the received encoded data and outputs the resulting secondary video to the display video formation unit 108.

The base time counter unit 110 counts the base time for decoding and outputs the base time to the video decoder 1 (104), video decoder 2 (105), graphics decoder 1 (106), graphics decoder 2 (107), display video formation unit 108, and comparison unit 112.

The video decoder 1 (104), video decoder 2 (105), graphics decoder 1 (106), and graphics decoder 2 (107) perform decoding processing based on the base time output from the base time counter unit 110. This allows the information to be decoded with synchronization established among the primary video information, secondary video information, subtitle information, and menu information.

In addition, the auxiliary information is read from the optical disc 101 or the local storage 102. In this embodiment, the auxiliary information associated with the secondary video information is read from the local storage 102 to implement the picture in picture function. The auxiliary information that is read is sent to the auxiliary information analysis unit 109. The auxiliary information analysis unit 109 analyzes the auxiliary information and extracts the effective area information and the application time information on the secondary video. The extracted effective area information is sent to the control unit 111, and the extracted application time information is sent to the comparison unit 112.

The comparison unit 112 compares the application time information with the base time received from the base time counter 110 and outputs the comparison result to the control unit 111.

When the comparison result received from the comparison unit 112 indicates a “match”, the control unit 111 sends a secondary video display instruction to the display video formation unit 108 with the effective area information, received from the auxiliary information analysis unit 109, specified for the instruction.

The display video formation unit 108 combines the primary video information, secondary video information, and graphics information to create an output video image. At this time, the display video formation unit 108 combines the secondary video information into the output video screen based on the instruction content received from the control unit 111.

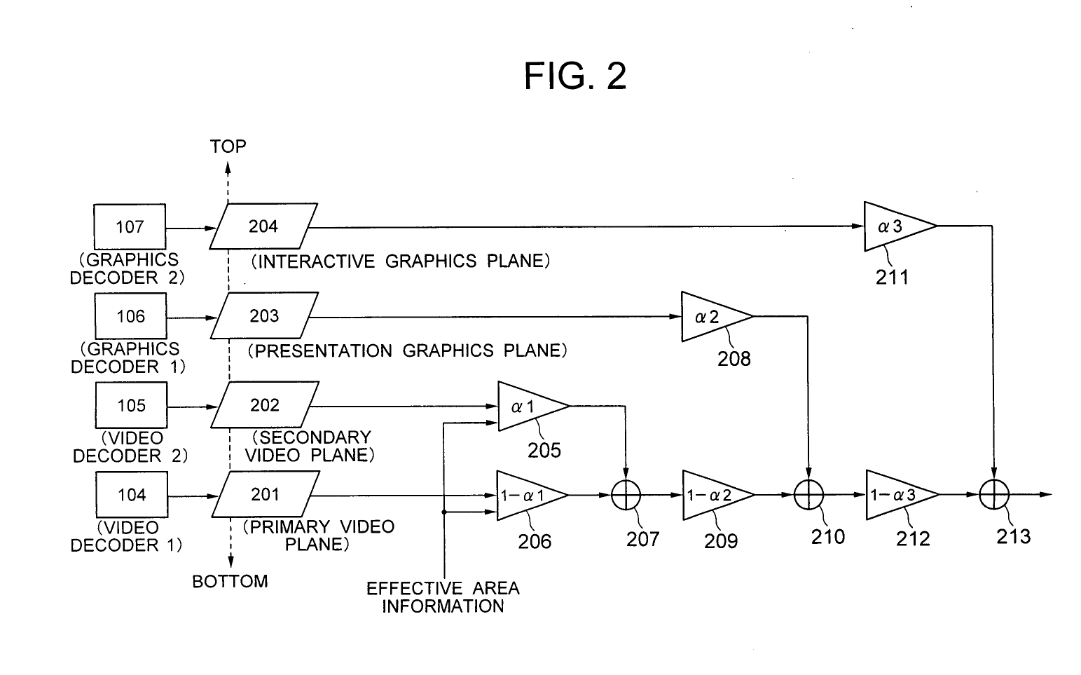

The following describes the operation of the display video formation unit 108 more in detail with reference to FIG. 2.

FIG. 2 is a diagram showing an example of the configuration of the display video formation unit 108. The numeral 201 indicates a primary video plane, the numeral 202 indicates a secondary video plane, the numeral 203 indicates a presentation graphics plane, the numeral 204 indicates an interactive graphics plane, the numerals 205, 206, 208, 209, 211, and 212 indicate multipliers, and numerals 207, 210, and 213 indicate adders. The same reference numerals are used for the corresponding elements of FIG. 1.

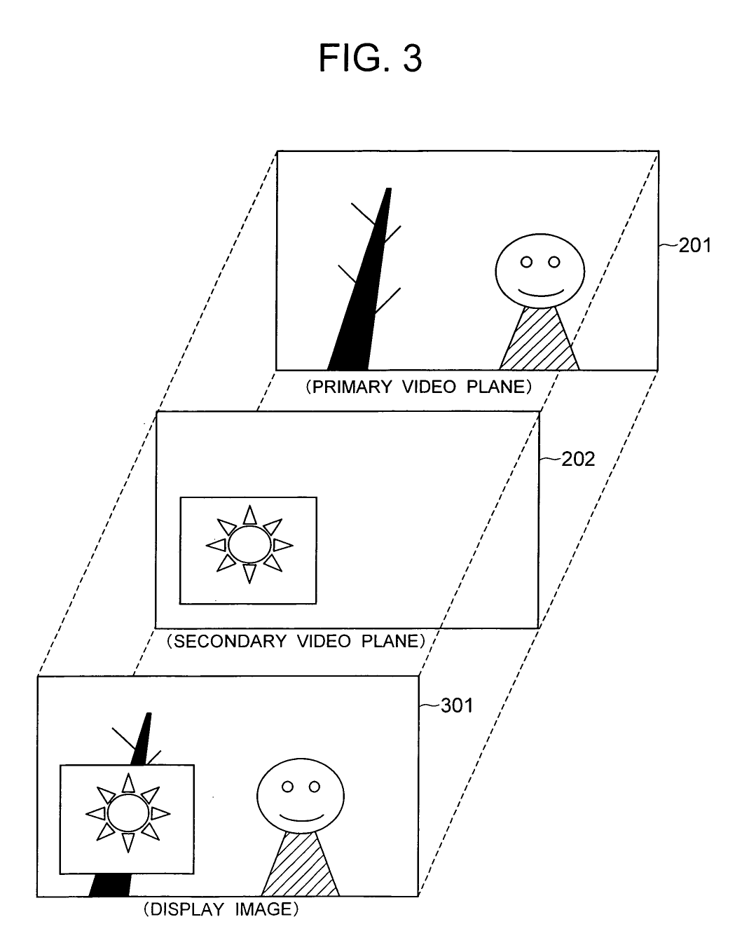

This embodiment is characterized in that the effective area of the secondary video information stored in the secondary video plane 202 is limited and in that the effective area information is separately input to the multipliers 205 and 206. If the effective area limitation and the effective area information described above are not applied, the configuration is basically the same as the conventional configuration. To describe the characteristics of this embodiment, the following first describes the basic display mode of a picture in picture video in the conventional example described above with reference to FIG. 3.

The primary video information output from the video decoder 1 (104) is stored in the primary video plane 201. The secondary video information output from the video decoder 2 (105) is stored in the secondary video plane 202. As shown in FIG. 3, both the primary video plane 201 and the secondary video plane 202 are the HD size, while the secondary video information has the resolution comparable to that of an HD size video but the effective area is the SD size and, as shown in the figure, the video is pasted only in a part of the secondary video plane 202.

The secondary video plane 202 is placed before the primary video plane 201 in the display order. When a video is output, data is read from the video planes on a pixel basis and the opacity level α1 (1 or 0 in this case) is applied to the multipliers 205 and 206 to output a display video 301 in FIG. 3. That is, in this case, the opacity level is 1(α1=1) in the SD-size rectangular area stored in the secondary video plane 202, and the opacity level is 0(α1=0) in the other area. The outputs of the multipliers 205 and 206 are added up by the adder 207, the opacity level α2 is applied by the multipliers 208 and 209, and the result is combined with the subtitle information, stored in the presentation graphics plane 203, by the adder 210. In addition, the opacity level α3 is applied to the output of the adder 210 by the multipliers 211 and 212, the result is combined with the menu information, stored in the interactive graphics plane 204, by the adder 213, and the final display video is output. How image data is combined with subtitle information and menu information is described in the prior-art example described above and, so, the output example is not shown in the figure in this embodiment.

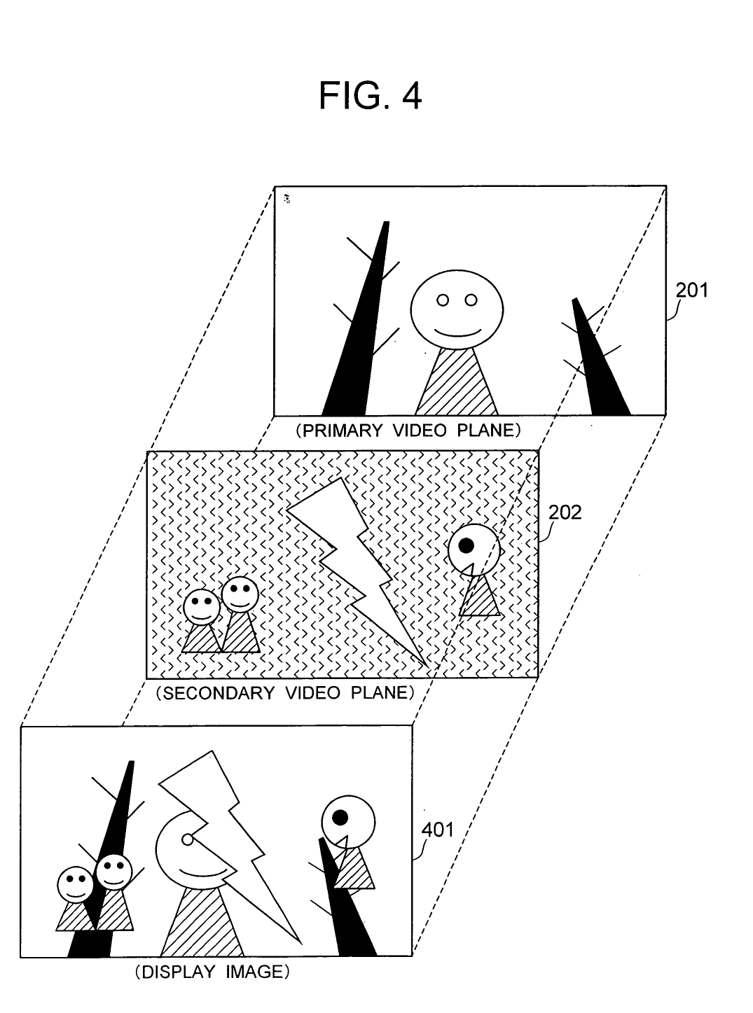

Next, referring to FIG. 4, the following describes a case in which an HD-size image is simply used as the secondary video information. As shown by the secondary video plane 202 in FIG. 4, the secondary video information is the standard HD size. The opacity level α1 is evaluated for the whole HD size area of the outputs of the primary video plane and the secondary video plane and, finally, a display video 401 is output. In this case, α1 is determined by performing processing to make α1=0 for all pixels whose brightness or color difference component is equal to or lower than (or equal to or higher than) a predetermined value. This opacity level determination method, based on pixel components, is a standard image configuration method (for example, chroma key) and, therefore, the detailed description is omitted.

When an HD-size video is used for the secondary video information as described above, the video decoder 2 (105) is always required to decode the HD size video and the processing amount, combined with that of the video decoder 1 (104), sometimes becomes very large.

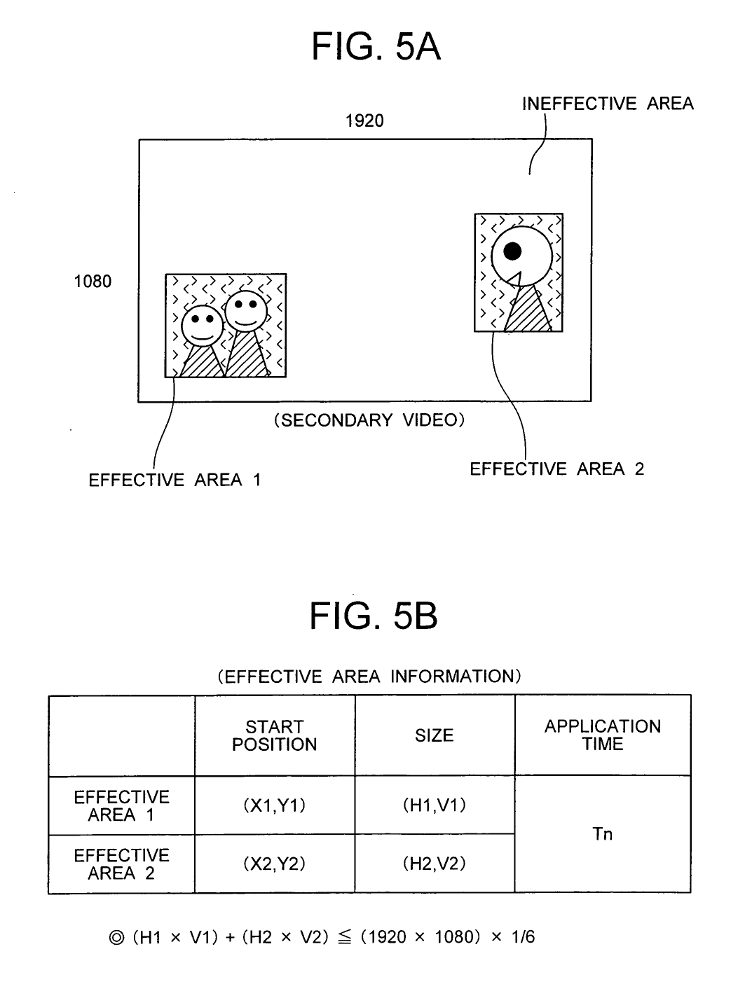

To solve this problem, the effective area of secondary video information is limited in this embodiment as shown in FIGS. 5A and 5B. As shown in FIG. 5A, a content creator encodes a video in a form in which only the areas required for secondary video information are shown and, at the same time, generates area information on the effective areas as shown in FIG. 5B. For example, by limiting the total size value of the effective areas to ⅙ or smaller of the HD size, the effective encoding value becomes the SD size even if the video information is encoded at the HD size.

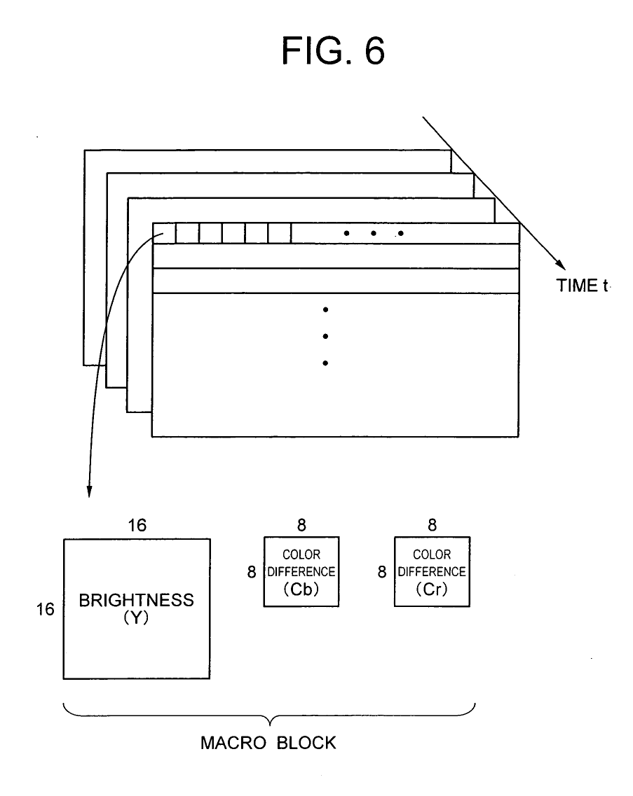

The following briefly describes a more specific example in which secondary video information is encoded in the MPEG2 video format. In the MPEG2 video format, the temporal and spatial correlations between video frames are calculated, and differential values are encoded, as shown in FIG. 6. The correlation is calculated for each predetermined unit (macro block) composed of the brightness and the color difference, and the video is encoded in such a way that an ineffective area within one frame is processed as a skip macro block (minimum coding amount).

However, when the video is directly reproduced as the secondary video information, the ineffective area is not always combined correctly by the opacity determination method described above. So, the effective area information shown in FIG. 5B is entered into the multipliers 205 and 206 as the determination elements of the opacity level α1 shown in FIG. 2. In the multipliers 205 and 206, α1=0 is used for areas other than the effective areas, that is, ineffective areas, according to the effective area information to always keep the primary video information displayed. In the effective area, the opacity level determination method (chroma key, etc.) is used separately.

As described above, the secondary video information is encoded at the HD size in this embodiment but in such a way that the ratio of the HD-size video in the effective area is equal to or lower than a predetermined ratio and, at the reproduction time, the effective area information is also used to combine the primary video information and the secondary video information. This method reduces the processing amount of the decoder and carries out a desired image combination even when the picture in picture function is executed.

In this embodiment, only a slight change in the encoding result of the ineffective area of the secondary video information is basically considered and, regardless of the state, the opacity level of the ineffective area is unconditionally set to 0 using the effective area information. Instead of this method, it is also possible to achieve a desired effect by limiting the effective area ratio at encoding time and applying the above-described opacity-level determination method (chroma key, etc.) to the whole area of the decoded secondary video information, for example, if the ineffective area can be encoded in the uniform state. Although the secondary video is encoded in the MPEG2 video format in this embodiment, the present invention can be applied to any format in which an image is encoded with code assigned primarily to the effective area.

### Second Embodiment

Next, a second embodiment of the present invention will be described below.

The block diagram of a reproduction apparatus in this embodiment is the same as that of the reproduction apparatus in FIG. 1 and, therefore, the detailed description is omitted. This embodiment differs from the first embodiment in that the secondary video information is the SD size and is smaller than the size of the primary video information on the screen. As described in the first embodiment, the SD-size secondary video information requires a smaller processing amount of the video decoder than the HD-size video information. However, when the secondary video is the SD size, the usable area of the secondary video plane 202 is limited and multiple small screens cannot be combined in different positions.

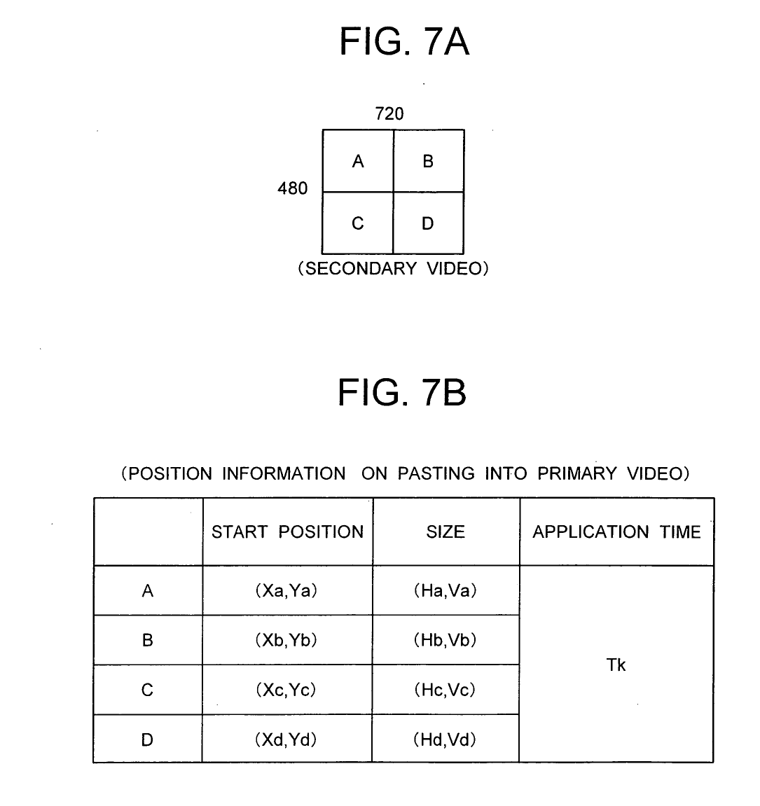

To solve this problem, the secondary video information is divided, for example, into four as shown in FIG. 7A in this embodiment, and the video is encoded as SD-size videos with different persons placed in the areas. In addition, as shown in FIG. 7B, the position information indicating where each of the divided areas is finally placed in the primary video information display, as well as the application time, is also generated and provided. That is, the auxiliary information analysis unit 109 in FIG. 1 extracts the divided-area position information and the application time from the auxiliary information and sends them to the display video formation unit 108 via the control unit 111.

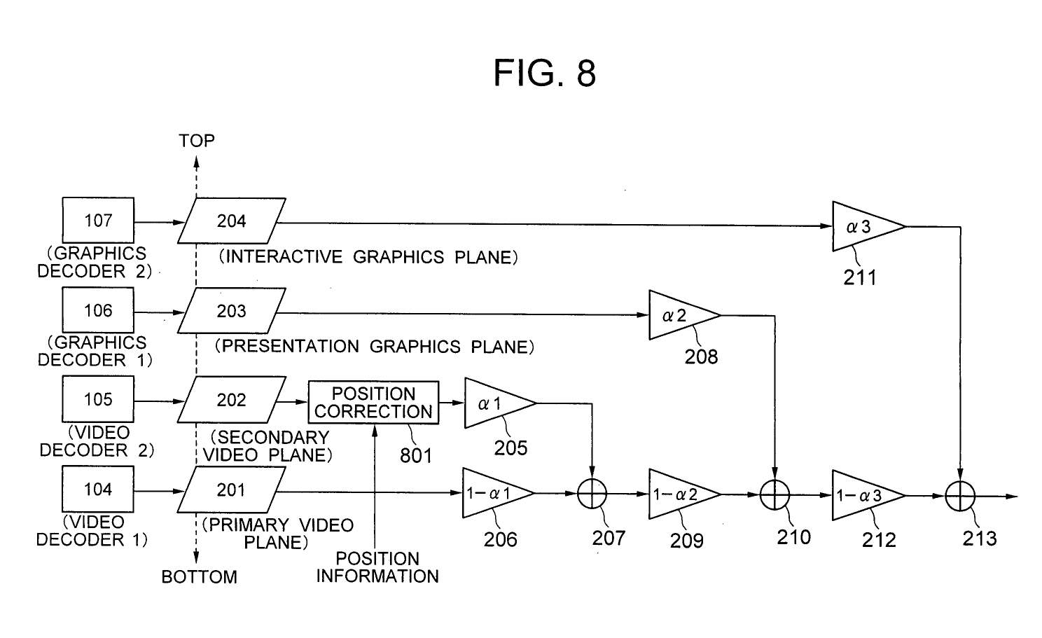

FIG. 8 is a diagram showing an example of the configuration of the display video formation unit 108 used in the above case. The same reference numerals are used for the corresponding elements of FIG. 2 and the detailed description is omitted. Divided-area paste position information output from the control unit 111 is input to a position correction unit 801. Data read from the secondary video plane 202 on a pixel basis has its position corrected by the position correction unit 801 according to the position information, the opacity level is applied to the data, and the result is added up.

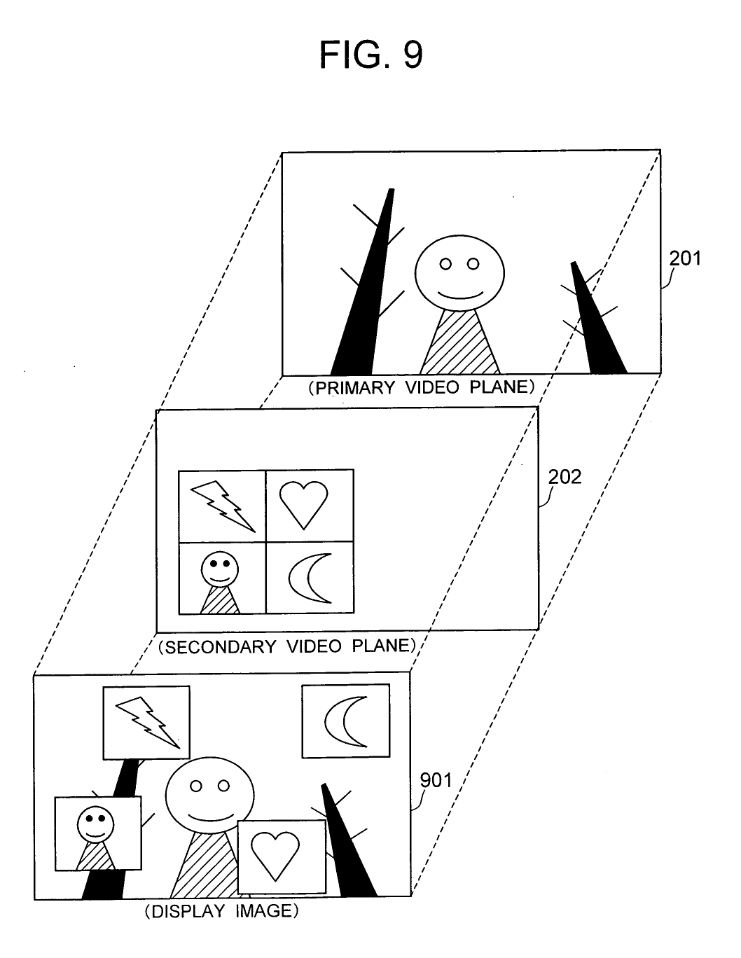

FIG. 9 shows a specific example in this case. The secondary video information is encoded at the SD size, and the area is divided into four. The secondary video information, which is the SD size in the video plane 202, has the display position of each of its areas corrected by the position correction unit 801 and, finally, the display video is output by the picture in picture function in such a way that the desired small areas are displayed in any positions as shown in 901.

As described above, the picture in picture function in this embodiment can display small windows in multiple positions while limiting the processing amount of the secondary video to the processing amount corresponding to the SD size.

Although the position correction unit 801 is placed after the secondary video plane 202 in this embodiment, the same effect can be achieved by placing the position correction unit before the secondary video plane 202. In this case, the decoded secondary video information, whose position information is corrected, is stored in the secondary video plane 202.

### Third Embodiment

Next, a third embodiment of the present invention will be described.

This embodiment relates to a recording apparatus that records video information on a recording medium from which the reproduction apparatus in the first embodiment and the second embodiment reproduces data.

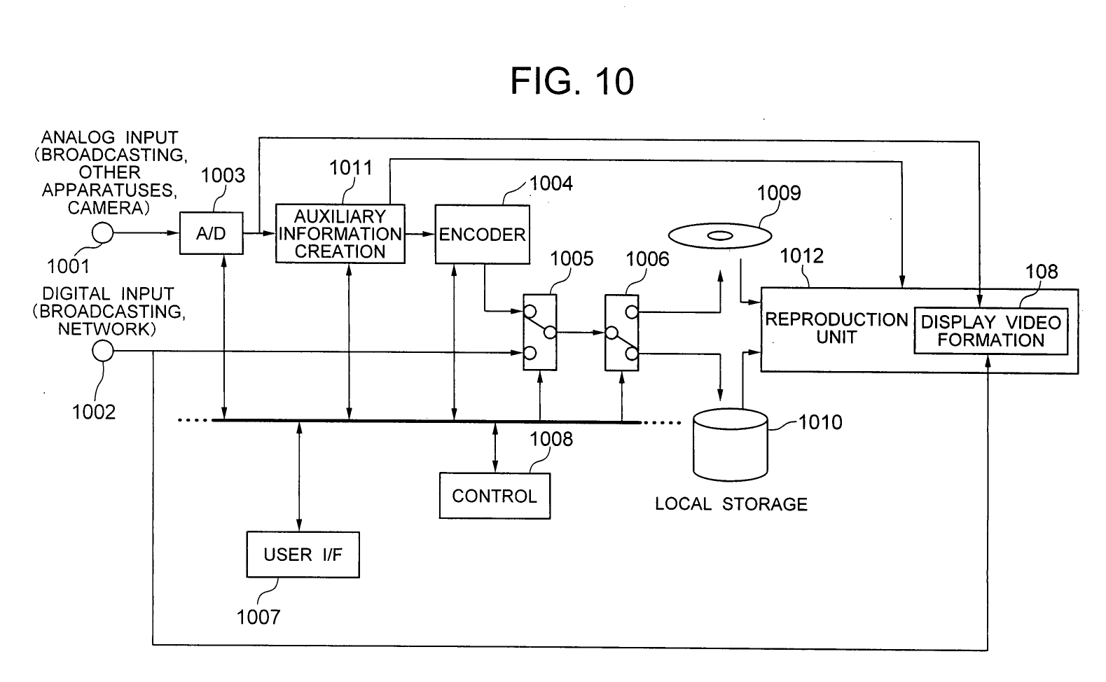

FIG. 10 is a block diagram showing a recording apparatus in this embodiment. The numeral 1001 indicates an analog input terminal via which secondary video information is input from a camera or other devices. Although analog information is input in this embodiment, the information is not limited to analog information but digital information may also be input. The numeral 1002 indicates a digital input terminal via which primary video information that is broadcast or that is sent from a network is input. The numeral 1003 indicates A/D conversion means that converts analog information, output from the analog input terminal 1001, to digital information. If the secondary video information is input in the form of digital signals, no conversion is performed. The numeral 1011 indicates auxiliary information creation means that creates effective area information and application time information on secondary video information. The numeral 1004 indicates an encoder that encodes digital secondary video information. The numeral 1005 indicates video information selection means that selects one of secondary video information that is encoded and primary video information that is output from the digital input terminal 1002. The numeral 1006 indicates medium selection means that selects a medium on which information is to be recorded. The numeral 1009 indicates an optical disc and the numeral 1010 indicates a hard disk, and they are local storage. The numeral 1007 indicates a user I/F via which an instruction is accepted from the user. The numeral 1008 indicates a control unit that controls the recording apparatus in its entirety. The control unit 1008 may be combined with the control unit 111 of a reproduction unit 1012. The reproduction unit 1012 is a reproduction unit, which performs the reproduction-side operation described in the first embodiment or the second embodiment, has display video formation means 108. The display video formation means 108 receives secondary video information, received via the analog input terminal 1001, and primary video information, received via the digital input terminal 1002, and combines the information into a video to be displayed on the display screen based on the effective area information and application time information created by the auxiliary information creation means 1011.

This embodiment is characterized in that the effective area information and the application time information on secondary video information are created and, along with the secondary video information, recorded on a recording medium. This recording operation creates a recording medium for use in the first embodiment and the second embodiment. The data capacity of an ineffective area, which is not an effective area, is so small that the load of the control unit 1008 can be reduced. In addition, the reproduction of a picture in picture video from this recording medium reduces the burden of the control unit 111.

Although the primary video information is digital information output from the digital input terminal 1002 in the description above, the present invention does not limit the primary video information to digital information but, like the secondary video information, the primary video information may be input in the analog format and converted from analog to digital by the A/D conversion means.

Although the primary video information and the secondary video information are recorded at the same time in the description above, it is also possible that, after the primary video information is recorded, the secondary video information is input and recorded in synchronization with the reproduction of the primary video information from the recording medium. Conversely, it is also possible that, after the secondary video information is recorded, the primary video information is input and recorded in synchronization with the reproduction of the secondary video information from the recording medium.

In addition, to increase or decrease the range of the effective area of the secondary video information or to change the position of the range when the information, in which the primary video information, secondary video information, and auxiliary information are multiplexed, is received, the auxiliary information is separated, the effective area information and the application time information included in the auxiliary information are changed and then re-multiplexed and recorded. The secondary video information and the auxiliary information, which are in the format of the first embodiment, may be converted to the format in the second embodiment or, conversely, the secondary video information and the auxiliary information, which are in the format of the second embodiment, may be converted to the format in the first embodiment, before being recorded. This conversion and recording is another embodiment.

In the embodiments described above, the secondary video to be reproduced as a picture in picture video is encoded at the HD size, the ratio of its effective area to the whole image is set equal to or lower than a predetermined value and, at the same time, the auxiliary information, such as the area information on the effective area and its application time information, is attached to the moving-image stream to be displayed as the secondary video. The reproduction method and the reproduction apparatus have the auxiliary information analysis means and, at the reproduction time, an ineffective area other than the effective area in the secondary video is made transparent at an appropriate time according to the extracted area information.

A secondary video in the second embodiment to be reproduced as a picture in picture video is encoded at the SD size, and the auxiliary information, such as the divided-area paste position information and the application time information, is attached to a moving-image stream to be displayed as the secondary video. The reproduction method and the reproduction apparatus have the auxiliary information analysis means and, if the secondary video is encoded at the SD size, the predetermined divided-areas to be displayed as the secondary video is displayed and overplayed on the primary video according to the extracted position information at an appropriate time.

When a secondary video to be reproduced as a picture in picture video is encoded at the HD size, its effective area is virtually set equal to or smaller than a predetermined area within the whole image and, so, the encoding rate can be kept low while maintaining the image quality. Because the ineffective area is made transparent at reproduction time, the primary video is not hidden in an area other than the effective area in the picture in picture video.

According to the reproduction method and the reproduction apparatus, when a secondary video to be reproduced as a picture in picture video is encoded at the SD size, the divided-area position information is attached to the moving-image stream to be displayed as the secondary video to allow multiple small-area images to be displayed in desired positions as picture in picture videos at reproduction time. Even when the primary video is the HD size, the secondary video is encoded at the SD size and, therefore, the encoding rate and the processing amount can be reduced.

While the reproduction method, reproduction apparatus, recording method, and recording apparatus have been described in the above embodiments, a recording medium that can be used in one of the first to third embodiments is also an embodiment. Using such a recording medium reduces the load of the reproduction processing.

Although the embodiments in which both the effective area information and the application time information are used as the auxiliary information are described, the application time information is not, of course, used for a still image.

Although the resolution size of the effective area of the secondary video information is set to a ratio equal to or lower than a predetermined ratio of the resolution size of the primary video information, the resolution size of the effective area of the secondary video information is only required to be lower than the resolution size of the primary video information in order to reduce the burden of the reproduction processing. However, the reproduction apparatus is designed more easily when the resolution size of the effective area of the secondary video information is equal to or lower than a predetermined ratio.

Although the primary video information is sent via broadcasting or a network and the secondary video information is sent from other apparatuses, such as a camera, or via broadcasting and a network in the above description, the information source is not limited to them. For example, the information may be the one reproduced from the optical disc 1009 or local storage 1010; in this case, editing information and recording the edited information back to the same recording medium or onto a different recording medium is also another embodiment.

Another embodiment is a video display apparatus that comprises a reception unit for receiving the primary video information and the secondary video information and a display unit for displaying the primary video information and the secondary video information and that corresponds to the reproduction apparatus in the first embodiment and the second embodiment.

It should be further understood by those skilled in the art that although the foregoing description has been made on embodiments of the invention, the invention is not limited thereto and various changes and modifications may be made without departing from the spirit of the invention and the scope of the appended claims.

1. A reproduction apparatus comprising:
first decoding module that decodes encoded data of primary video information; and
second decoding module that decodes encoded data of secondary video information, wherein
said reproduction apparatus can output the secondary video information on a display apparatus in synchronization with the primary video information, and
a size of an effective area of the secondary video information on a screen is smaller than a size of the primary video information on the screen,
said reproduction apparatus further comprising display video formation module that forms a display video using the primary video information and the secondary video information.

2. The reproduction apparatus according to claim 1 wherein
the size of the effective area of the secondary video information on the screen is equal to or lower than a predetermined ratio of the size of the primary video information on the screen.

3. The reproduction apparatus according to claim 1 wherein
the size of the primary video information on the screen is equal to the size of the secondary video information on the screen and the secondary video information has an effective area and an ineffective area.

4. The reproduction apparatus according to claim 1 wherein
the effective area is an area displayed on a display video formed by said display video formation module.

5. The reproduction apparatus according to claim 1,
further comprising auxiliary information analysis module that analyzes auxiliary information on the effective area of the secondary video information; and
control module that controls said display video formation module, wherein
said control module uses the auxiliary information to give an instruction to said display video formation module to control an opacity level of the display of the secondary video information.

6. The reproduction apparatus according to claim 5 wherein
the auxiliary information includes application time information that is information on a time at which the auxiliary information is applied,
said reproduction apparatus further comprising:
a base time counter that indicates a base time for video decoding and display; and
comparison module that compares the application time information with said base time counter, wherein
said control module uses the auxiliary information to give the instruction to said display video formation module based on an output result of said comparison module and controls the opacity level of the display of the secondary video information.

7. The reproduction apparatus according to claim 1 wherein
said display video formation module comprises first storage module that stores the primary video information and second storage module that stores the secondary video information, wherein
an output of said first storage module and an output of said second storage module can be combined while switching the opacity level on a pixel basis.

8. The reproduction apparatus according to claim 1 wherein
said first decoding module and said second decoding module are formed by single decoding module.

9. The reproduction apparatus according to claim 1 wherein
said first decoding module and said second decoding module are implemented by software.

10. A reproduction method comprising the steps of:
decoding encoded data of primary video information and encoded data of secondary video information; and
outputting the secondary video information on a display apparatus in synchronization with the primary video information, wherein
a size of an effective area of the secondary video information on a screen is smaller than a size of the primary video information on the screen and
a display video is formed using the primary video information and the secondary video information.

11. A recording method for recording primary video information and secondary video information, comprising the steps of:
specifying an effective area of the secondary video information; and
recording the specified effective area along with the secondary video information, said specified effective area recorded as auxiliary information, wherein
a size of the effective area of the secondary video information on a screen is smaller than a size of the primary video information on the screen and
the primary video information and the secondary video information are recorded so that the primary video information and secondary video information are synchronized on a display screen.

12. The recording method according to claim 11 wherein
the size of the effective area of the secondary video information on the screen is equal to or lower than a predetermined ratio of the size of the primary video information on the screen.

13. The recording method according to claim 11 wherein
the size of the primary video information on the screen is equal to the size of the secondary video information on the screen and the secondary video information has an effective area and an ineffective area.

14. A video display apparatus comprising:
a reception unit that receives primary video information and secondary video information;
first decoding module that decodes encoded data of the primary video information;
second decoding module that decodes encoded data of the secondary video information; and
a display unit that displays the secondary video information in synchronization with the primary video information, wherein
a size of an effective area of the secondary video information on a screen is smaller than a size of the primary video information on the screen,
said image display apparatus further comprising display video formation module that forms a display video using the primary video information and the secondary video information.

15. A recording medium on which primary video information and secondary video information are recorded, wherein
auxiliary information on an effective area of the secondary video information is recorded,
a size of the effective area of the secondary video information on a screen is smaller than a size of the primary video information on the screen, and
the primary video information and the secondary video information are synchronized and displayed on the screen.

16. A reproduction apparatus comprising:
first decoding module that decodes encoded data of primary video information; and
second decoding module that decodes encoded data of secondary video information, wherein
said reproduction apparatus can output the secondary video information on a display apparatus in synchronization with the primary video information,
a size of the secondary video information on a screen is smaller than a size of the primary video information on the screen, and
the secondary video information is displayed in a divided form,
said reproduction apparatus further comprising display video formation module that forms a display video using the primary video information and the secondary video information; and
control module that controls the display video formation module.

17. The reproduction apparatus according to claim 16 wherein
the size of the secondary video information on the screen is equal to or lower than a predetermined ratio of the size of the primary video information on the screen.

18. The reproduction apparatus according to claim 16,
further comprising auxiliary information analysis module that analyzes auxiliary information on position information on multiple divided areas of the secondary video information, wherein
said control module uses the auxiliary information to give an instruction to said display video formation module to control a divided display of the secondary video information.

19. The reproduction apparatus according to claim 18 wherein
the auxiliary information includes application time information that is information on a time at which the auxiliary information is applied,
said reproduction apparatus further comprising:
a base time counter that indicates a base time for video decoding and display; and
comparison module that compares the application time information with said base time counter, wherein
said control module uses the auxiliary information to give the instruction to said display video formation module based on an output result of said comparison module and controls display positions of the divided areas of the secondary video information.

20. The reproduction apparatus according to claim 16 wherein
said display video formation module comprises first storage module that stores the primary video information and second storage module that stores the secondary video information, wherein
an output of said first storage module and an output of said second storage module can be combined while switching the opacity level on a pixel basis.

21. The reproduction apparatus according to claim 16 wherein
said first decoding module and said second decoding module are formed by single decoding module.

22. The reproduction apparatus according to claim 16 wherein
said first decoding module and said second decoding module are implemented by software.

23. A reproduction method comprising the steps of:
decoding encoded data of primary video information and encoded data of secondary video information; and
outputting the secondary video information on a display apparatus in synchronization with the primary video information, wherein
a size of the secondary video information on a screen is smaller than a size of the primary video information on the screen,
the secondary video information is displayed in a divided form, and
a display video is formed using the primary video information and the secondary video information.

24. A recording method for recording primary video information and secondary video information, comprising the steps of:
creating auxiliary information on position information on multiple divided areas of the secondary video information; and
recording the created auxiliary information along with the secondary video information, wherein
a size of the secondary video information on a screen is smaller than a size of the primary video information on the screen and
the primary video information and the secondary video information are recorded so that the primary video information and secondary video information are synchronized on a display screen.

25. The recording method according to claim 24 wherein
the size of the secondary video information on the screen is equal to or lower than a predetermined ratio of the size of the primary video information on the screen.

26. A video display apparatus comprising:
a reception unit that receives primary video information and secondary video information;
first decoding module that decodes encoded data of the primary video information;
second decoding module that decodes encoded data of the secondary video information; and
a display unit that displays the secondary video information in synchronization with the primary video information, wherein
a size of the secondary video information on a screen is smaller than a size of the primary video information on the screen, and
the secondary video information is displayed in a divided form,
said image display apparatus further comprising display video formation module that forms a display video using the primary video information and the secondary video information.

27. A recording medium on which primary video information and secondary video information are recorded, wherein
auxiliary information that is position information on the secondary video information is recorded,
a size of the secondary video information on a screen is smaller than a size of the primary video information on the screen,
the secondary video information is displayed in a divided form, and
the primary video information and the secondary video information are synchronized and displayed on the screen.
